(19) United States
(12) Patent Application Publication
(10) Pub. No.: US 2006/0137799 A1
(43) Pub. Date: Jun. 29, 2006

(54) Thermoplastic composites with improved sound absorbing capabilities

(76) Inventors: Enamul Haque, Novi, MI (US); Terry Cheney, Northville, MI (US); Arthur Blinkhorn, Fenton, MI (US)

Correspondence Address: OWENS CORNING, 2790 COLUMBUS ROAD, GRANVILLE, OH, 43023, US

(21) Appl. No.: 11/027,925

(22) Filed: Dec. 29, 2004

(51) Int. Cl. B27N 3/00; B32B 37/00

(52) U.S. Cl. 156/62.2; 156/182; 156/245

(57) ABSTRACT

A composite material formed of reinforcement fibers, acoustical enhancing fibers such as polyethylene terephthalate (PET) fibers or modified polyethylene terephthalate fibers, and one or more organic fibers is provided. The acoustical enhancing fiber may be any fiber that provides increased or enhanced acoustical absorbance, particularly at low frequencies. The composite material may be formed by partially opening wet reinforcing fibers, acoustical enhancing fibers, and organic fibers, mixing the reinforcing, acoustical enhancement, and organic fibers, forming the fibers into a sheet, and bonding the fibers in the sheet. Preferably the reinforcing fibers are wet use chopped strand glass fibers. The composite material may be formed of a single layer of reinforcement, acoustical enhancement fibers, and organic fibers. Alternatively, the composite material may be a multi-layered composite in which the acoustical enhancement fibers are located in an acoustical layer laminated to a thermal layer formed of the organic fibers and reinforcement fibers.

TECHNICAL FIELD AND INDUSTRIAL APPLICABILITY OF THE INVENTION

The present invention relates generally to acoustical products, and more particularly, to a composite material that includes reinforcement fibers, organic fibers, and polyethylene terephthalate (PET) fibers and which possesses improved sound absorption at lower frequencies. A method of forming the composite material is also provided.

### BACKGROUND OF THE INVENTION

Sound insulation materials are used in a variety of settings where it is desired to dampen noise from an external source. For example, sound insulation materials have been used in applications such as in appliances to reduce the sound emitted into the surrounding areas of a home, in automobiles to reduce mechanical sounds of the motor and road noise, and in office buildings to attenuate sound generated from the workplace, such as from telephone conversations or from the operation of office equipment. Conventional acoustical insulation materials include materials such as foams, compressed fibers, fiberglass batts, felts, and nonwoven webs of fibers such as meltblown fibers. Acoustical insulation typically relies upon both sound absorption (the ability to absorb incident sound waves) and transmission loss (the ability to reflect incident sound waves) to provide adequate sound attenuation.

In automobiles, the insulation material also relies upon thermal shielding properties to reduce or prevent the transmission of heat from various heat sources in the automobile (engine, transmission, exhaust, etc.) to the passenger compartment of the vehicle. Such insulation is commonly employed in the automobile as a headliner, dash liner, or firewall liner. Liners are typically formed of laminates of one or more layers of an insulation material to provide desired mechanical strength properties and one or more additional layers of a rigid material to permit simple and convenient installation in the automobile as well as proper functional performance. Examples of conventional acoustical insulation materials are set forth below.

U.S. Pat. No. 4,889,764 to Chenoweth et al. and U.S. Pat. No. 4,946,738 describe a non-woven fibrous blanket that includes mineral fibers (glass fibers), synthetic fibers (polyester), and bi-component fibers. The synthetic fibers preferably have lengths of from ¼ to 4 inches and a deniers ranging from 1-15 denier. The bicomponent fibers preferably have lengths from ¼-3 inches and deniers ranging from 1-10 denier.

U.S. Pat. No. 5,591,289 to Souders et al. discloses a headliner that has a fibrous core formed from a high loft batting of polymeric thermoplastic fibers (polypropylene and polyethylene terephthalate). The fibers have a length of approximately 2 inches and a denier in the range of from 5-30.

U.S. Pat. No. 5,662,981 to Olinger et al. describes a molded composite product that has a resinous core layer that contains reinforcement fibers (glass and polymer fibers) and a resinous surface layer that is substantially free of reinforcement fibers. The surface layer may be formed of thermoplastics or thermoset materials such as poytretrafluoroethylene, polyethylene terephthalate (PET), polyvinyl chloride (PVC), polyphenylene sulfide (PPS), or polycarbonate.

U.S. Pat. No. 5,886,306 to Patel et al. discloses a layered acoustical insulating web that includes a series of cellulose fiber layers sandwiched between a layer of melt-blown or spun-bond thermoplastic fibers (polypropylene) and a layer of film, foil, paper, or spunbond thermoplastic fibers.

U.S. Pat. No. 6,669,265 to Tilton et al. describes a fibrous material that has a lofty, acoustically insulating portion and a relatively higher density skin that may function as a water barrier. The fibrous material includes polyester, polyethylene, polypropylene, polyethylene terephthalate (PET), glass fibers, natural fibers, and mixtures thereof.

U.S. Pat. No. 6,695,939 to Nakamura et al. discloses an interior trim material that is formed of a substrate and a skin bonded to the substrate. The substrate is a mat-like fiber structure that is a blend of thermoplastic and inorganic fibers. The skin is a high melting point fiber sheet formed from fibers that have a melting point higher than the melting point of the thermoplastic fibers in the substrate. The high melting point fibers may be polyethylene terephthalate (PET) fibers.

U.S. Pat. No. 6,756,332 to Sandoe et al. describes a headliner that includes a core layer formed from a batt of blended non-woven fibers between two stiffening layers. The core layer includes thermoplastic fibers having (1) 20-50% fine fibers by weight with a denier in the range of 0.8-3.0, (2) 10-50% binder fibers by weight, and (3) other fibers with deniers in the range of 4.0-15.0. The thermoplastic fibers can include polyester, polyolefin, and nylon. The polyester fibers preferably include bicomponent fibers.

U.S. Patent Publication No. 2003/0039793 A1 to Tilton et al. describes a trim panel insulator for a vehicle that includes a nonlaminate acoustical and thermal insulating layer of polymer fibers. The insulator may also include a relatively high density, nonlaminate skin of polymer fibers and/or one or more facing layers formed of polyester, polypropylene, polyethylene, rayon, ethylene vinyl acetate, polyvinyl chloride, fibrous scrim, metallic foil, and mixtures thereof.

U.S. Patent Publication No. 2004/0002274 A1 to Tilton discloses a laminate material that includes (1) a base layer formed of polyester, polypropylene, polyethylene, fiberglass, natural fibers, nylon, rayon, and blends thereof and (2) a facing layer. The base layer has a density of from approximately 0.5-15.0 pcf and the facing layer has a density of between about 10 pcf and about 100 pcf.

U.S. Patent Publication No. 2004/0023586 A1 to Tilton et al. and U.S. Patent Publication No. 2003/0008592 to Block et al. disclose a fibrous blanket material that has a first fibrous layer formed of polyester, polypropylene, polyethylene, fiberglass, natural fibers, nylon, and/or rayon and a layer of meltblown polypropylene fibers. A second fibrous layer may be sandwiched between the first fibrous layer and the layer of meltblown fibers. The blanket material may be tuned to provide sound attenuation for a particular product application.

U.S. Patent Publication No. 2004/0077247 to Schmidt et al. describes a nonwoven laminate that contains a first layer formed of thermoplastic spunbond filaments having an average denier less than about 1.8 dpf and a second layer containing thermoplastic multicomponent spunbond filaments having an average denier greater than about 2.3 dpf. The laminate has a structure such that the density of the first layer is greater than the density of the second layer and the thickness of the second layer is greater than the thickness of the first layer.

Although there are numerous acoustical insulation products in existence in the art for automotive applications, none of the existing insulation products provide sufficient sound absorption at low frequencies while maintaining sufficient structural properties. Thus, there exists a need for acoustical materials that exhibit superior sound attenuating properties, improved structural and thermal properties, and that are lightweight and low in cost.

### SUMMARY OF THE INVENTION

It is an object of the present invention to provide a method for making an acoustic and thermally absorbent composite material that includes reinforcing fibers, organic fibers, and acoustical enhancement fibers. To form the composite material, wet reinforcement fibers are opened and filamentized and at least a portion of the water present in the wet reinforcement fibers is removed to form dehydrated reinforcement fibers. The dehydrated reinforcement fibers are blended with acoustical enhancement fibers and organic fibers, such as in a high velocity air stream, to form a substantially homogenous mixture of the fibers. The mixture is then transferred to a sheet former and formed into a sheet. At least some of the dehydrated reinforcement fibers, organic fibers, and acoustical enhancement fibers are bonded to form a composite material. In at least one exemplary embodiment, the sheet is heated to a temperature above the melting point of the organic fibers and/or acoustical enhancement fibers and below the melting point of the dehydrated reinforcing fibers to at least partially melt the organic fibers and/or acoustical enhancement fibers and bond the reinforcement, organic, and acoustical enhancement fibers together. In a preferred embodiment, the reinforcement fibers are wet use chopped strand glass fibers. The acoustical enhancement fibers are preferably polyethylene terephthalate fibers and/or modified polyethylene terephthalate fibers.

It is another object of the present invention to provide a method of forming a laminate composite product. In a first assembly line, a first layered material that includes sequential layers of a scrim, a first adhesive, a composite material that includes reinforcing fibers, acoustical enhancement fibers, and organic fibers, and a second adhesive is formed. In a second assembly line, a second layered material formed of a core layer of polyethylene terephthalate fibers and/or modified polyethylene terephthalate fibers, a third adhesive layer, a composite material that includes reinforcing fibers, acoustical enhancement fibers, and organic fibers, and a fourth adhesive layer is produced. The first and second assembly lines may converge in-line such that the second adhesive layer is positioned adjacent to the polyethylene terephthalate fiber core layer. The layered composite thus formed may be passed through a lamination oven where heat and pressure are applied to form a laminated composite material. The laminated composite material may be further processed by conventional methods into composite products such as a liner for an automobile. For example, the laminated composite material may be trimmed and formed into a headliner, such as by a molding process. Foam or fabric may then be applied to the headliner for aesthetic purposes.

It is yet another object of the present invention to provide a method of making a composite material that is formed of (1) a first layer that includes reinforcing fibers and organic fibers and (2) a second layer that includes acoustical enhancement fibers. To form the first layer, bales of wet reinforcing reinforcement fibers are opened and filamentized and at least a portion of the water present in the wet reinforcing fibers is removed to form dehydrated reinforcing fibers. The dehydrated reinforcing fibers are mixed with organic fibers to form a substantially homogenous mixture of fibers. The mixture is then transferred to a sheet former and formed into a sheet. At least some of the dehydrated reinforcement fibers and organic fibers are bonded to form the first layer. In at least one exemplary embodiment, the sheet is heated to a temperature above the melting point of the organic fibers and below the melting point of the dehydrated reinforcing fibers to at least partially melt the organic fibers and bond the reinforcing and organic fibers together. In a preferred embodiment, the reinforcement fibers are wet use chopped strand glass fibers. A second layer of acoustical enhancement fibers is positioned on the first layer to form the composite product. It is preferred that the acoustical enhancement fibers are polyethylene terephthalate fibers and/or modified polyethylene terephthalate fibers. In addition, the second layer may be formed by an air-laid, wet-laid, or meltblown process. The second layer may optionally include heat fusible fibers such as bicomponent fibers. The acoustical behavior of the composite product may be fine tuned by altering the lengths and denier of the acoustical enhancement fibers.

It is an advantage of the present invention that the acoustic performance of the composite material may be altered or improved by the specific combination of fibers present in the composite material, and can therefore be tailored to meet the needs of a particular application. For example, the acoustic properties desired for specific applications can be optimized by altering the weight of the fibers, by changing the reinforcement fibers content and/or length or diameter of the reinforcement fibers, or by altering the fiber length and/or denier of the acoustical enhancing fibers or organic fibers.

It is another advantage of the present invention that the thickness of composite parts formed from the composite material, the porosity of the formed composite parts (void content), and the air flow path of the formed composite parts may be controlled by changing the basis weight of the organic fibers and/or reinforcement fiber content of the composite material.

It is a further advantage that the composite material formed in a dry-laid process that uses wet use chopped strand glass such as in the present invention has a higher loft (increased porosity).

It is yet another advantage of the present invention that the composite material provides the ability to optimize and/or tailor the physical properties needed for specific applications (such as stiffness or strength) by altering the weight, length, and/or denier of the reinforcement fibers and/or organic fibers used in the composite material.

It is a further advantage of the present invention that composite materials formed by the processes described herein have a uniform or substantially uniform distribution of fibers, thereby providing improved strength as well as improved acoustical and thermal properties, strength, stiffness, impact resistance, and acoustical absorbance.

It is another advantage of the present invention that when wet use chopped strand glass fibers are used as the reinforcing fiber material, the glass fibers may be easily opened and fiberized with little generation of static electricity due to the moisture present in the glass fibers.

It is also an advantage of the present invention that the final product formed can be manufactured at lower costs because wet use chopped strand glass fibers are less expensive to manufacture than dry chopped fibers (dry fibers are typically dried and packaged in separate steps before being chopped).

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a flow diagram illustrating steps for using wet reinforcement fibers in a dry-laid process according to one aspect of the present invention;

FIG. 2 is a schematic illustration an air-laid process using wet reinforcement fibers to form a composite material according to at least one exemplary embodiment of the present invention;

FIG. 3 is a schematic illustration of a composite material formed of an acoustical layer and a thermal layer according to at least one exemplary embodiment of the present invention;

FIG. 4 is a schematic illustration of an air-laid process utilizing acoustical enhancement fibers and polymeric fibers to form an acoustical layer according to at least one exemplary embodiment of the present invention;

FIG. 5 is a schematic illustration of a laminate process for making a layered composite product according to at least one exemplary embodiment of the present invention;

FIG. 6 is a schematic illustration of the layered composite product formed by the exemplary process depicted in FIG. 5;

FIG. 7 is a graphical illustration of the random incident sound absorption of a conventional polypropylene/glass composite material and a polypropylene/glass/polyethylene terephthalate composite material according to the present invention; and

FIG. 8 is a graphical illustration of the normal incident sound absorption of a conventional polypropylene/glass composite material and a polyethylene terephthalate/glass composite material according the present invention.

### DETAILED DESCRIPTION AND PREFERRED EMBODIMENTS OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, or any other references, are each incorporated by reference in their entireties, including all data, tables, figures, and text presented in the cited references.

In the drawings, the thickness of the lines, layers, and regions may be exaggerated for clarity. It is to be noted that like numbers found throughout the figures denote like elements. The terms “top”, “bottom”, “side”, and the like are used herein for the purpose of explanation only. It will be understood that when an element such as a layer, region, substrate, or panel is referred to as being “on” another element, it can be directly on the other element or intervening elements may be present. If an element or layer is described as being “adjacent to” or “against” another element or layer, it is to be appreciated that the element or layer may be directly adjacent or directly against that other element or layer, or intervening elements may be present. It will also be understood that when an element such as a layer, region, or substrate is referred to as being “over” another element, it can be directly over the other element, or intervening elements may be present. The terms “reinforcing fibers” and “reinforcement fibers” may be use interchangeably herein. Further, the term “acoustical enhancement fibers” may be used interchangeably with the term “acoustical enhancing fibers”.

The present invention relates to an acoustic and thermally absorbent composite material that is formed of reinforcement fibers, acoustical enhancing fibers such as polyethylene terephthalate (PET) fibers or modified polyethylene terephthalate fibers, and one or more organic fibers. The composite material may be utilized in numerous structural applications such as in automobiles (head liners, hood liners, floor liners, trim panels, parcel shelves, vehicle sunshades, instrument panel structures, door inners, and the like), and in wall panels and roof panels of recreational vehicles (RV's) as well as in a number of non-structural acoustical applications such as in kitchen appliances, in office screens and partitions, in ceiling tiles, in building panels, and in basement finishing systems.

The reinforcement fibers utilized in the composite material may be any type of organic or inorganic fiber suitable for providing good structural qualities as well as good acoustical and thermal properties. Non-limiting examples of reinforcement fibers that may be utilized in the composite material include glass fibers, wool glass fibers, natural fibers, metal fibers, ceramic fibers, mineral fibers, carbon fibers, graphite fibers, nanofibers, and combinations thereof. The term “natural fiber” as used in conjunction with the present invention refers to plant fibers extracted from any part of a plant, including, but not limited to, the stem, seeds, leaves, roots, or bast. In the composite material, the reinforcement fibers may have the same or different lengths, diameters, and/or denier. Preferably, the reinforcing fiber material is glass fibers.

The reinforcement fibers utilized in the composite material may have a length of from approximately 10-100 mm in length, and even more preferably, a length of from 25-50 mm. Additionally, the reinforcing fibers may have diameters of from 11-25 microns, and preferably have diameters of from 12-18 microns. The reinforcing fibers may have varying lengths (aspect ratios) and diameters from each other within the composite material. The reinforcing fibers may be present in the composite material in an amount of from 20-60% by weight of the total fibers, and are preferably present in the composite material in an amount of from 30-50% by weight.

In addition, the composite material includes at least one acoustical enhancing fiber. The acoustical enhancing fiber may be any fiber that provides increased or enhanced acoustical absorbance, particularly at lower frequencies, such as, for example, frequencies below approximately 2000 Hz. Non-limiting examples of such fibers include polyethylene terephthalate (PET) fibers and modified polyethylene terephthalate fibers (such as poly 1,4 cyclohexanedimethyl terephthalate, glycol modified polyethylene terephthalate), cotton and jute fibers (cellulosic and natural), glass fibers, and polyurethane foam. Preferably, the acoustical enhancement fibers are polyethylene terephthalate fibers or modified polyethylene terephthalate fibers. The acoustical enhancing fibers may have different denier and fiber lengths to provide increased sound absorption. The acoustical enhancing fibers utilized in the composite material may have a length of from approximately 6-75 mm in length, and preferably have a length of from 18-50 mm. In addition, the acoustical enhancing fibers may have a denier from approximately 1.5-30 denier, preferably from 1.5-6 denier. The acoustical enhancing fibers may present in the composite material in an amount of from 30-70% by weight of the total fibers, and are preferably present in an amount of from 30-40% by weight.

Additionally, the composite material includes at least one organic fiber. The organic fibers present in the composite material may include polymer based thermoplastic fibers such as, but not limited to, polyester fibers, polyethylene fibers, polypropylene fibers, polyethylene terephthalate (PET) fibers, polyphenylene sulfide (PPS) fibers, polyvinyl chloride (PVC) fibers, ethylene vinyl acetate/vinyl chloride (EVA/VC) fibers, lower alkyl acrylate polymer fibers, acrylonitrile polymer fibers, partially hydrolyzed polyvinyl acetate fibers, polyvinyl alcohol fibers, polyvinyl pyrrolidone fibers, styrene acrylate fibers, polyolefins, polyamides, polysulfides, polycarbonates, rayon, nylon and butadiene copolymers such as styrene/butadiene rubber (SBR) and butadiene/acrylonitrile rubber (NBR). The organic fibers may be functionalized with acidic groups, for example, by carboxylating with an acid such as a maleated acid or an acrylic acid, or the polymer fibers may be functionalized by adding an anhydride group or vinyl acetate. The organic fibers may alternatively be in the form of a flake, granule, or a powder rather than in the form of a polymer fiber. In some embodiments, a resin in the form of a flake, granule, and/or a powder is added in addition to the organic fibers.

One or more types of organic fibers may be present in the composite material. The specific combination of the types of organic fibers present in the composite material will vary to meet the specific acoustical requirements of a particular application. The organic fibers present in the composite material may have the same or different lengths, diameters, and/or denier. For example, the organic fibers of the composite material may include a single polymeric fibrous material (such as polypropylene) in which the polymer fibers have different lengths, diameters, and/or denier. As another example, the organic fibers present in the composite material may include two or more different polymeric fibrous materials, and each of the polymers may have the same lengths and/or diameters and/or denier, or, alternatively, the polymers may have different lengths and/or diameters and/or denier. The acoustical behavior of the composite material may be fine tuned by altering the lengths and denier of the organic polymer fibers. In addition, the ratio of the different organic fibers present in the composite material can be varied to achieve specific acoustic properties.

The organic fibers may have a length of from approximately 6-75 mm, and preferably have a length of from 18-50 mm. Additionally, the organic fibers may have a denier of from 2-30 denier, preferably from 2-18 denier, and more preferably, from 3-7 denier. The organic fibers present in the composite material may have varying lengths and diameters, depending on the desired acoustical characteristics of the composite material. The polymer fibers may be present in the composite material in an amount of from 10-50% by weight of the total fibers, and are preferably present in an amount of from 10-30% by weight.

One or more of the organic fibers may be a multicomponent fibers such as bicomponent polymer fibers, tricomponent fibers, or plastic-coated mineral fibers such as thermoplastic coated glass fibers. The bicomponent fibers may be arranged in a sheath-core, side-by-side, islands-in-the-sea, or segmented-pie arrangement. Preferably, the bicomponent fibers are formed in a sheath-core arrangement in which the sheath is formed of first polymer fibers which substantially surround the core formed of second polymer fibers. It is not required that the sheath fibers totally surround the core fibers. The first polymer fibers have a melting point lower than the melting point of the second polymer fibers so that upon heating the bicomponent fibers, the first and second polymer fibers react differently. In particular, when the bicomponent fibers are heated to a temperature that is above the melting point of the first polymer fibers (sheath fibers) and below the melting point of the second polymer fibers (core fibers), the first polymer fibers will soften or melt while the second polymer fibers remain intact. This softening of the first polymer fibers (sheath fibers) will cause the first polymer fibers to become sticky and bond the first polymer fibers to themselves and other fibers that may be in close proximity.

Numerous combinations of materials can be used to make the bicomponent polymer fibers, such as, but not limited to, combinations using polyester, polypropylene, polysulfide, polyolefin, and polyethylene fibers. Specific polymer combinations for the bicomponent fibers include polyethylene terephthalate/polypropylene, polyethylene terephthalate/polyethylene, and polypropylene/polyethylene. Other non-limiting bicomponent fiber examples include copolyester polyethylene terephthalate/polyethylene terephthalate (coPET/PET), poly 1,4 cyclohexanedimethyl terephthalate/polypropylene (PCT/PP), high density polyethylene/polyethylene terephthalate (HDPE/PET), high density polyethylene/polypropylene (HDPE/PP), linear low density polyethylene/polyethylene terephthalate (LLDPE/PET), nylon 6/nylon 6,6 (PA6/PA6,6), and glycol modified polyethylene terephthalate/polyethylene terephthalate (6PETg/PET).

The bicomponent polymer fibers may have a length of from 2-4 mm and a denier in the range of approximately 1-18 denier. It is preferred that the first polymer fibers (sheath fibers) have a melting point within the range of from about 150-400° F., and more preferably in the range of from about 170-300° F. The second polymer fibers (core fibers) have a higher melting point, preferably above about 350° F. When bicomponent fibers are used as a component of the composite material, the bicomponent fibers may be present in an amount up to 20% by weight of the total fibers, preferably in an amount up to 10% by weight.

The composite material may be formed of an air-laid, wet-laid, or meltblown non-woven mat or web of randomly oriented reinforcement fibers, acoustical enhancing fibers, and/or organic fibers. In at least one exemplary embodiment, the composite material is formed by a dry-laid process, such as the dry-laid process described in U.S. patent application Ser. No. 10/688,013, filed on Oct. 17, 2003, to Enamul Haque entitled “Development Of Thermoplastic Composites Using Wet Use Chopped Strand Glass In A Dry Laid Process”, incorporated herein by reference in its entirety. In preferred embodiments, the reinforcing fibers used to form the composite material are wet reinforcing fibers, and most preferably are wet use chopped strand glass fibers. Wet use chopped strand glass fibers for use as the reinforcement fibers may be formed by conventional processes known in the art. It is desirable that the wet use chopped strand glass fibers have a moisture content of from 5-30%, and more preferably have a moisture content of from 5-15%.

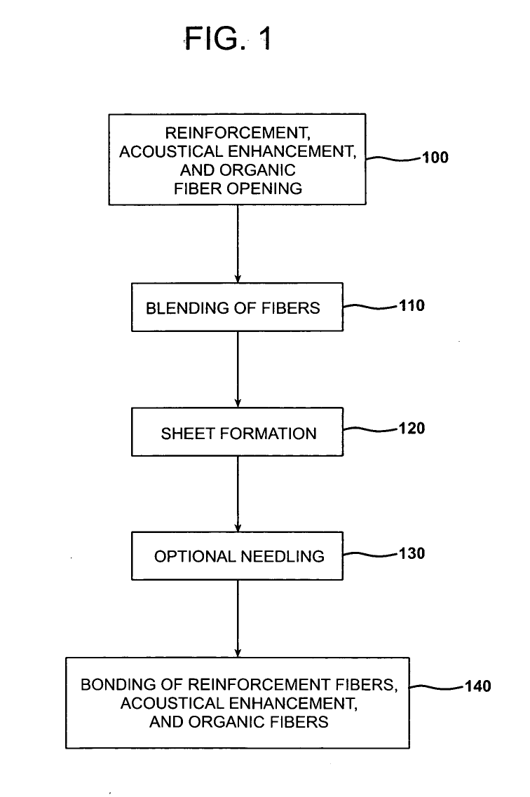

An exemplary process for forming a composite material in accordance with the instant invention is generally illustrated in FIG. 1, and includes at least partially opening the reinforcement fibers, the acoustical enhancing fibers, and the organic fibers (step 100), blending the reinforcement, acoustical enhancing fibers, and organic fibers (step 110), forming the reinforcement, acoustical enhancing, and organic fibers into a sheet (step 120), optionally needling the sheet to give the sheet structural integrity (step 130), and bonding the reinforcement, acoustical enhancing, and organic fibers (step 140).

The reinforcing fibers, acoustical enhancement fibers, and the organic fibers are typically agglomerated in the form of a bale of individual fibers. In forming the composite material, bales of reinforcing fibers, acoustical enhancing fibers, and organic fibers may each be opened by an opening system, such as a bale opening system, which is common in the industry.

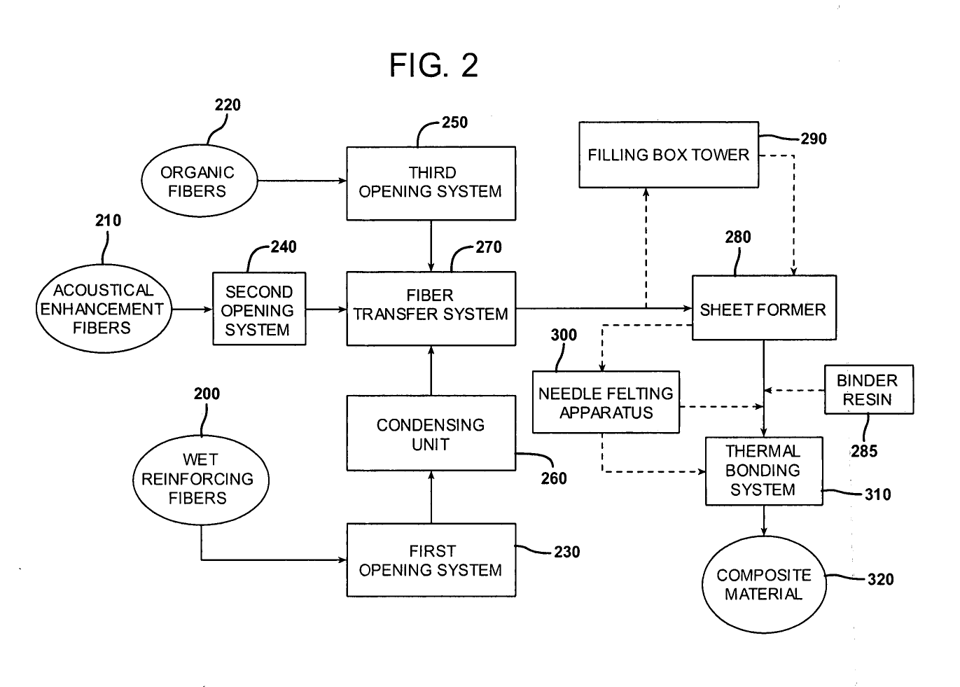

Turning now to FIG. 2, the opening of the wet reinforcement fibers, acoustical enhancement fibers, and the organic fibers can best be seen. Wet reinforcing fibers 200, acoustical enhancement fibers 210, and organic fibers 220, typically in the form of bales, are fed into a first opening system 230, a second opening system 240, and a third opening system 250 respectively to at least partially open and/or filamentize (individualize) the wet reinforcing fibers 200, acoustical enhancement fibers 210, and organic fibers 220. It is to be noted that although the exemplary process depicted in FIGS. 1 and 2 show opening the acoustical enhancement fibers 210 by a second opening system 240 and opening the organic fibers 220 by a third opening system 250, the acoustical enhancement fibers 210 and/or the organic fibers 220 may be fed directly into the fiber transfer system 270 (embodiment not illustrated) if the acoustical enhancement fibers 210 and/or organic fibers 220 are present or obtained in a filamentized form, and not in the form of a bale. Such embodiments are considered to be within the purview of this invention.

In alternate embodiments where the organic fibers are in the form of a flake, granule, or powder, the third opening system 250 may be replaced with an apparatus suitable for distributing the flakes, powders, or granules to the fiber transfer system 270 so that these resinous materials may be mixed with the reinforcement fibers 200 and acoustical enhancement fibers 210. A suitable distribution apparatus would be easily identified by those of skill in the art. In embodiments where a resin in the form of a flake, granule, or powder is used in addition to the organic fibers 220 (and not in place of), the apparatus distributing the flakes, granules, or powder may not replace the third opening system 250.

The first, second, and third opening systems 230, 240, 250 are preferably bale openers, but may be any type of opener suitable for opening the bales of reinforcing fibers 200, acoustical enhancement fibers 210, and organic fibers 220. The design of the openers depends on the type and physical characteristics of the fiber being opened. Suitable openers for use in the present invention include any conventional standard type bale openers with or without a weighing device. The weighing device serves to continuously weigh the partially opened fibers as they are passed through the bale opener to monitor the amount of fibers that are passed onto the next processing step. The bale openers may be equipped with various fine openers, one or more licker-in drums or saw-tooth drums, feeding rollers, and/or or a combination of a feeding roller and a nose bar.

The partially opened wet reinforcement fibers 200 may then be dosed or fed from the first opening system 230 to a condensing unit 260 to remove water from the wet fibers. In exemplary embodiments, greater than 70% of the free water (water that is external to the reinforcement fibers) is removed. Preferably, however, substantially all of the water is removed by the condensing unit 260. It should be noted that the phrase “substantially all of the water” as it is used herein is meant to denote that all or nearly all of the free water is removed. The condensing unit 260 may be any known drying or water removal device known in the art, such as, but not limited to, an air dryer, an oven, rollers, a suction pump, a heated drum dryer, an infrared heating source, a hot air blower, or a microwave emitting source.

After the reinforcement fibers 200 have passed through the condensing unit 260, the fibers may be passed through another opening system, such as a bale opener described above, to further filamentize and separate the reinforcement fibers 200 (not shown).

The reinforcing fibers 200, acoustical enhancement fibers 210, and organic fibers 220 are blended together by the fiber transfer system 270, preferably in a high velocity air stream. The fiber transfer system 270 serves both as a conduit to transport the reinforcing fibers 200, acoustical enhancement fibers 210, and organic fibers 220 to the sheet former 270 and to substantially uniformly mix the fibers in the air stream. It is desirable to distribute the reinforcing fibers 200, acoustical enhancement fibers 210, and organic fibers 220 as uniformly as possible. The ratio of reinforcing fibers 200, acoustical enhancement fibers 210, and organic fibers 220 entering the air stream in the fiber transfer system 270 may be controlled by the weighing device described above with respect to the first, second, and third opening systems 230, 240, 250 or by the amount and/or speed at which the fibers are passed through the opening systems 220, 230, 250. The ratio of reinforcement fibers 200 to acoustical enhancement fibers 210 to organic fibers 220 may be approximately 50:20:30, reinforcement fibers 200 to acoustical enhancement fibers 210 to organic fibers 220 respectively. However, it is to be appreciated that the ratio of fibers present within the air stream will vary depending on the desired structural and acoustical requirements of the final product.

Additional fibers such as chopped roving, dry use chopped strand glass (DUCS), glass fibers, natural fibers (such as jute, hemp, and kenaf), aramid fibers, metal fibers, ceramic fibers, mineral fibers, carbon fibers, graphite fibers, polymer fibers, or combinations thereof may be opened and filamentized by additional opening systems (not shown) depending on the desired composition of the composite material. These additional fibers may be added to the fiber transfer system 270 and mixed with the reinforcing, acoustical enhancement, and organic fibers 200, 210, 220. Alternatively, if the fibers are obtained in a filamentized form, they may be added to the fiber transfer system 270 without first passing through an opening system. When such additional fibers are added to the fiber transfer system 270, it is preferred that from about 10-30% by weight of the total fibers consist of these additional fibers.

Turning back to FIG. 2, the mixture of reinforcing fibers 200, acoustical enhancement fibers 210, and organic fibers 220 may be transferred to a sheet former 280 where the fibers are formed into a sheet. In at least one exemplary embodiment, the mixture of fibers is transferred to the sheet former 280 by a high velocity air stream. In some embodiments of the present invention, the blended fibers are transported by the fiber transfer system 270 to a filling box tower 290 where the reinforcing fibers 200, acoustical enhancement fibers 210, and organic fibers 220 are volumetrically fed into the sheet former 280, such as by a computer monitored electronic weighing apparatus, prior to entering the sheet former 280. The filling box tower 290 is desirably positioned external to the sheet former 280. The filling box tower 290 may also include baffles to further blend and mix the reinforcement fibers 200, acoustical enhancement fibers 210, and organic fibers 220 prior to entering the sheet former 280. In some embodiments, the sheet former 280 has a condenser and a distribution conveyor to achieve a higher fiber feed into the filling box tower 290 and to increase the volume of air through the filling box tower 290. In order to achieve an improved cross-distribution of the opened fibers, the distributor conveyor may run transversally to the direction of the sheet. As a result, the reinforcing fibers 200, acoustical enhancement fibers 210, and organic fibers 220 may be transferred into the filling box tower 290 with little or no pressure and minimal fiber breakage.

In at least one exemplary embodiment, the sheet formed by the sheet former 280 is transferred to a second sheet former (not shown). The second sheet former assists in substantially uniformly distributing the reinforcement fibers 200, acoustical enhancement fibers 210, and organic fibers 220 in the sheet. In addition, the use of an additional sheet former may increase the structural integrity of the formed sheet. In an alternative embodiment (not shown), the mixture of reinforcing fibers 200, acoustical enhancement fibers 210, and organic fibers 220 are blown onto a drum or series of drums covered with fine wires or teeth to comb the fibers into parallel arrays prior to entering the sheet former 280 (not shown), as in a carding process.

The sheet formed by the sheet former 280 contains a substantially uniform distribution of bundles of reinforcing fibers 210, acoustical enhancement fibers 210, and organic fibers at a desired ratio and weight distribution. The sheet formed by the sheet former 270 may have a weight distribution of from 400-3000 g/m², with a preferred weight distribution of from about 600 to 2000 g/m².

In one or more embodiments of the invention, the sheet exiting the sheet former 280 is optionally subjected to a needling process in a needle felting apparatus 300 in which barbed or forked needles are pushed in a downward and/or upward motion through the fibers of the sheet to entangle or intertwine the reinforcing fibers 200, acoustical enhancement fibers 210, and organic fibers 220 and impart mechanical strength and integrity to the sheet. The needle felting apparatus 300 may include a web feeding mechanism, a needle beam with a needleboard, barbed felting needles ranging in number from about 500 per meter to about 7,500 per meter of machine width, a stripper plate, a bed plate, and a take-up mechanism. Mechanical interlocking of the reinforcement fibers 200, acoustical enhancement fibers 210, and organic fibers 220 is achieved by passing the barbed felting needles repeatedly into and out of the sheet. An optimal needle selection for use with the particular fibers chosen for use in the inventive process would be easily identified by one of skill in the art.

Either after the sheet exits the sheet former 280 or after the optional needling of the sheet, the sheet may be passed through a thermal bonding system 310 to bond the reinforcement fibers 200, acoustical enhancement fibers 210, and organic fibers 220 and form the composite material. However, it is to be appreciated that if the sheet is needled in the needle felting apparatus 300 and the reinforcing fibers 200, acoustical enhancement fibers 210, and the organic fibers 220 are mechanically bonded, the sheet may not need to be passed through the thermal bonding system 310 to form the composite material 320.

In thermal bonding, the thermoplastic properties of the acoustical enhancement fibers 210 and organic fibers 220 are used to form bonds with the reinforcement fibers 200 upon heating. In the thermal bonding system 290, the sheet is heated to a temperature that is above the melting point of the acoustical enhancement fibers 210 and/or the organic fibers 220 but below the melting point of the reinforcement fibers 200. When bicomponent fibers are used as the organic fibers 220, the temperature in the thermal bonding system 310 is raised to a temperature that is above the melting temperature of the sheath fibers, but below the melting temperature of the reinforcement fibers 200. Heating the acoustical enhancement fibers 210 and/or the organic fibers 220 to a temperature above their melting point, or the melting point of the sheath fibers in the instance where the organic fibers 220 are bicomponent fibers, causes the acoustical enhancement fibers 210 and/or organic fibers 220 to become adhesive and bond the acoustical enhancement fibers 210, organic fibers 220, and reinforcing fibers 200. If the acoustical enhancement fibers 210 and/or organic fibers completely melt, the melted fibers may encapsulate the reinforcement fibers 200. As long as the temperature within the thermal bonding system 310 is not raised as high as the melting point of the reinforcing fibers 200 and/or core fibers, these fibers will remain in a fibrous form within the thermal bonding system 310 and composite material 320.

Although the acoustical enhancement fibers 210 and/or the organic fibers 220 may be used to bond the reinforcement fibers 200 to each other, a binder resin 285 may be added as an additional bonding agent prior to passing the sheet through the thermal bonding system 310. The binder resin 285 may be in the form of a resin powder, flake, granule, foam, or liquid spray. The binder resin 285 may be added by any suitable manner, such as, for example, a flood and extract method or by spraying the binder resin 285 on the sheet. The amount of binder resin 285 added to the sheet may be varied depending of the desired characteristics of the composite material. A catalyst such as ammonium chloride, p-toluene, sulfonic acid, aluminum sulfate, ammonium phosphate, or zinc nitrate may be used to improve the rate of curing and the quality of the cured binder resin 285.

Another process that may be employed to further bond the reinforcing fibers 200 either alone, or in addition to, the other bonding methods described herein, is latex bonding. In latex bonding, polymers formed from monomers such as ethylene (T_{g} −125° C.), butadiene (T_{g} −78° C.), butyl acrylate (T_{g} −52° C.), ethyl acrylate (T_{g} −22° C.), vinyl acetate (T_{g} 30° C.), vinyl chloride (T_{g} 80° C.), methyl methacrylate (T_{g} 105° C), styrene (T_{g} 105 C.), and acrylonitrile (T_{g} 130° C.) are used as bonding agents. A lower glass transition temperature (T_{g}) results in a softer polymer. Latex polymers may be added as a spray prior to the sheet entering the thermal bonding system 310. Once the sheet enters the thermal bonding system 310, the latex polymers melt and bond the reinforcement fibers 200 together.

A further optional bonding process that may be used alone, or in combination with the other bonding processes described herein, is chemical bonding. Liquid based bonding agents, powdered adhesives, foams, and, in some instances, organic solvents can be used as the chemical bonding agent. Suitable examples of chemical bonding agents include, but are not limited to, acrylate polymers and copolymers, styrene-butadiene copolymers, vinyl acetate ethylene copolymers, and combinations thereof. For example, polyvinyl acetate (PVA), ethylene vinyl acetate/vinyl chloride (EVA/VC), lower alkyl acrylate polymers, styrene-butadiene rubber, acrylonitrile polymer, polyurethane, epoxy resins, polyvinyl chloride, polyvinylidene chloride, and copolymers of vinylidene chloride with other monomers, partially hydrolyzed polyvinyl acetate, polyvinyl alcohol, polyvinyl pyrrolidone, polyester resins, and styrene acrylate may be used as a chemical bonding agent. The chemical bonding agent may be applied uniformly by impregnating, coating, or spraying the sheet.

The thermal bonding system may include any known heating and bonding method known in the art, such as oven bonding, oven bonding using forced air, infrared heating, hot calendaring, belt calendaring, ultrasonic bonding, microwave heating, and heated drums. Optionally, two or more of these bonding methods may be used in combination to bond the fibers in the sheet. The temperature of the thermal bonding system 310 varies depending on the melting point of the particular acoustical enhancement fibers 210, organic fibers 220, binder resins, and/or latex polymers used, and whether or not bicomponent fibers are present in the sheet.

In an alternate embodiment (not illustrated), the composite material is formed by a wet-laid process. For example, reinforcing fibers, acoustical enhancement fibers, and organic fibers may be dispersed in an aqueous solution that contains a binder as well as dispersants, viscosity modifiers, defoaming agents, and/or other chemical agents and agitated to form a slurry. The reinforcement fibers, acoustical enhancement fibers, and organic fibers located in the slurry are then deposited onto a moving screen where water is removed. Optionally, the mat is dried in an oven. The mat may then be immersed in a binder composition to impregnate the mat with the binder composition. The mat is then passed through a curing oven to remove any remaining water, cure the binder, and at least partially melt the acoustical enhancement fibers and/or organic fibers to bind the reinforcing fibers, acoustical enhancement fibers, and organic fibers together. The resulting composite material is an assembly of dispersed thermoplastic fibers (acoustical enhancement fibers and organic fibers) and reinforcement fibers.

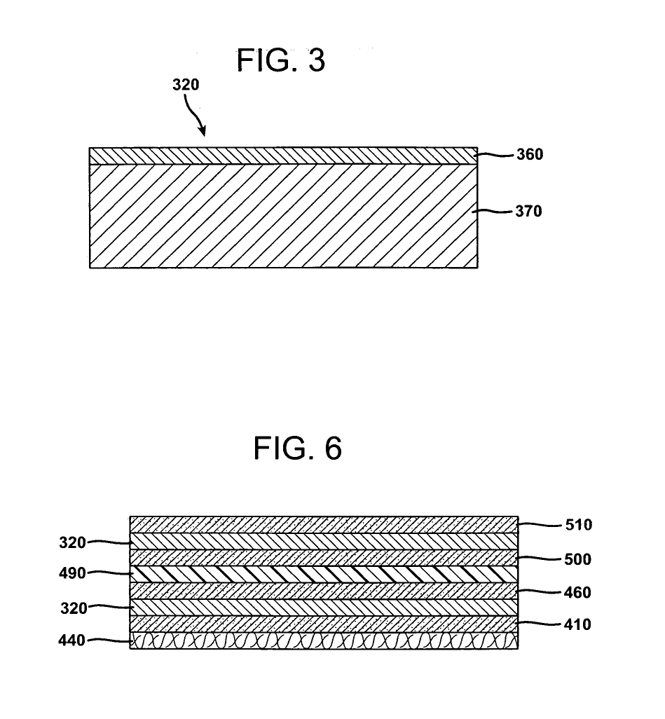

In the exemplary embodiment illustrated in FIG. 3, the composite material 320 is formed of an acoustical layer 360 and a thermal layer 370. In this embodiment, the acoustical enhancement fibers 210 are located in the acoustical layer 360 affixed or laminated to the thermal layer 370, which is formed of organic fibers 220 and reinforcement fibers 200. The thermal layer 370 may be made by the process described above and depicted in FIGS. 1 and 2 except that the acoustical enhancement fibers are absent. It is to be understood that the nomenclature for the acoustical layer 360 and the thermal layer 370 are used for ease of discussion herein and that both the acoustical layer 360 and the thermal layer 370 provide both acoustical and thermal insulating properties.

The acoustical layer 360 may be a non-woven mat formed by an air-laid, wet-laid, or meltblown process, and is desirably formed of 100% of the acoustical enhancing fibers 210 described above. Alternatively, the acoustical layer 360 may be formed of one or more acoustical enhancing fibers 210 and a polymer based thermoplastic organic material such as, but not limited to, polyester, polyethylene, polypropylene, polyphenylene sulfide (PPS), polyvinyl chloride (PVC), polyolefins, polyamides, polysulfides, polycarbonates, and mixtures thereof. Additionally, the acoustical layer 360 may include heat fusible fibers such as bicomponent fibers such as are described above. When bicomponent fibers are used as a component of the acoustical layer 360, they may be present in an amount of from 10-80% of the total fibers. The fibers forming the acoustical layer 360 may have the same or different lengths and/or diameters and/or denier.

The acoustical layer 360 is positioned on a major surface of the thermal layer 370, and may be attached to the thermal layer 370 such as by a nip-roll system or by using a laminator. Thus, the acoustical enhancement fibers 210 are located on one side of the composite material 320, and are not dispersed throughout the composite material as described above with respect to FIGS. 1 and 2. Resin tie layers such as Plexar™ (commercially available from Quantum Chemical), Admer™ (commercially available from Mitsui Petrochemical), and Bynel™ (an anhydride modified polyolefin commercially available from DuPont), spray-on adhesives, pressure sensitive adhesives, ultrasonics, vibration welding, or other commonly used fixation technologies may be used adhere the acoustical layer 360 and thermal layer 370.

The acoustical behavior of the composite product 320 formed of the thermal layer 370 and the acoustical layer 360 may be fine tuned by altering the lengths and denier of the acoustical enhancement fibers 210 and/or the polymer based thermoplastic organic material (if present) in the acoustical layer 360. In addition, the ratio of the acoustical enhancement fibers 210 to other fibrous polymeric materials that may be present in the acoustical layer 360 can be varied to achieve specific acoustic properties. In some exemplary embodiments, the length of the acoustical enhancement fibers 210 in the acoustical layer 360 is substantially the same length as the reinforcement fibers 200 present in the thermal layer 370 to aid in processing.

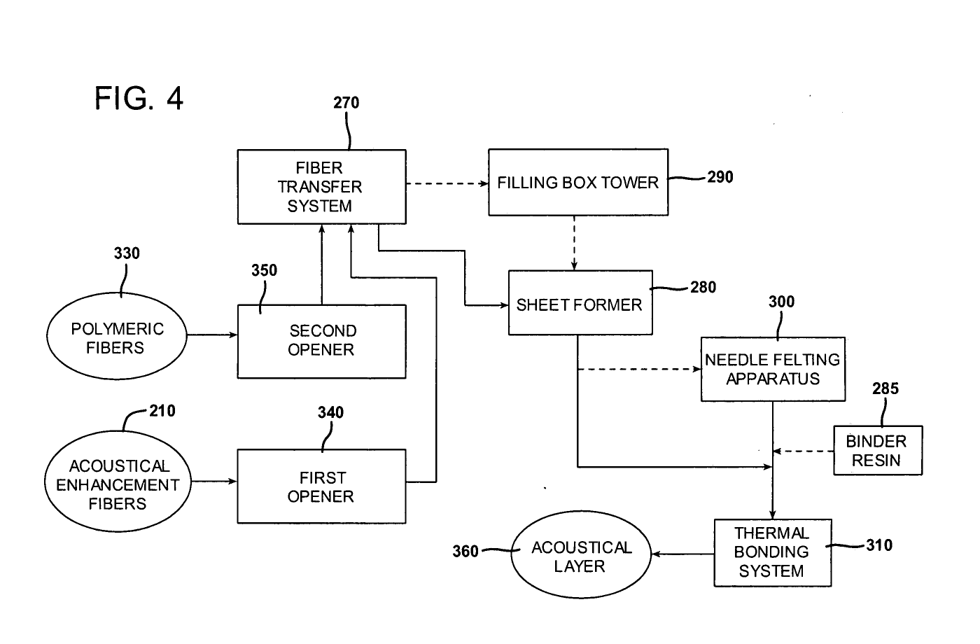

One exemplary embodiment of the formation of an acoustical layer 360 formed of acoustical enhancing fibers 210 and thermoplastic based polymer fibers in a dry-laid process is depicted in FIG. 4. It is to be appreciated that additional acoustical enhancement fibers and/or polymeric fibers may be used to form the acoustical layer 360 and that the particular fibers depicted in FIG. 4 are for illustration only. As shown in FIG. 4, acoustical enhancement fibers 210 and polymeric fibers 330 may be opened by passing the acoustical enhancement fibers 210 and the polymeric fibers 330, typically in the form of a bale, through a first opener 340 and a second opener 350, respectively, to open and filamentize the fibers.

The acoustical enhancement fibers 210 and polymeric fibers 330 may be blended together by the fiber transfer system 270, preferably in a high velocity air stream. Alternatively, the acoustical enhancing fibers 210 and the polymeric fibers 330 may be conveyed to a filling box tower 290 to volumetrically feed the acoustical enhancement fibers 210 and polymeric fibers 330 to the sheet former 280. The sheet exiting the sheet former 280 may then optionally be conveyed to a second sheet former (not shown) and/or a needle felting apparatus 300 for mechanical strengthening. A binder resin 285 may be added prior to passing the sheet through the thermal bonder 310 in a manner such as described above. The sheet is then passed through a thermal bonder 310 to cure the binder resin 285 (if present) and bond the acoustical enhancement fibers 210 and polymeric fibers 330.

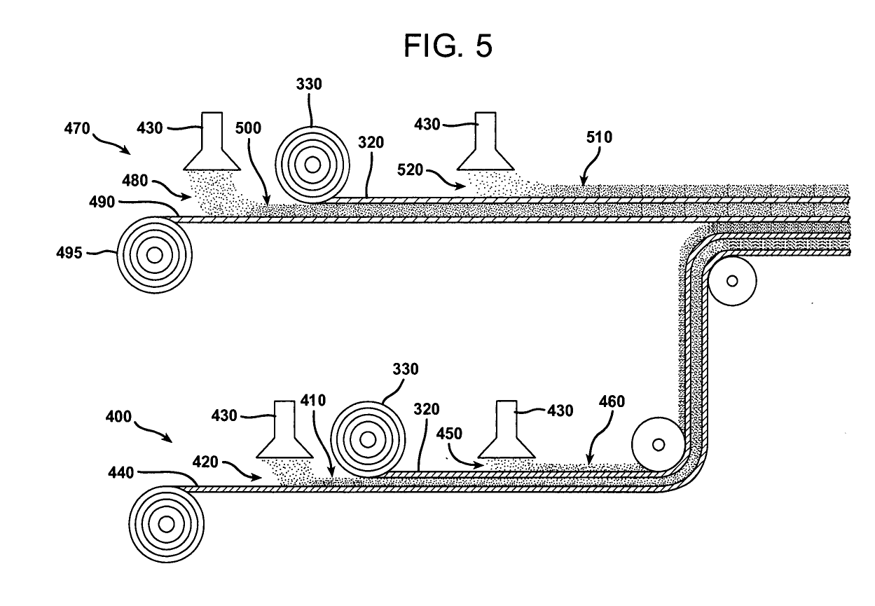

In another exemplary embodiment of the invention, the composite material is utilized in a laminate process to form a liner, such as a headliner, for an automobile. An example of such a laminate process is illustrated in FIG. 5. In a first assembly line 400, a first adhesive layer 410 formed of a first adhesive 420 is deposited onto a scrim 440 via a dispensing apparatus 430. A composite material 320 according to the instant invention is fed from a roll 330 and is laminated onto the first adhesive layer 410. A second adhesive 450 is deposited onto the composite material 320 to form a second adhesive layer 460. The first layered material thus produced includes sequential layers of a scrim 440, a first adhesive layer 410, a layer formed of a composite product 320, and a second adhesive layer 460.

In a second assembly line 470, a third adhesive 480 is deposited via a dispensing apparatus 430 onto a core layer of polyethylene terephthalate fibers 490 fed from a roll of polyethylene terephthalate 495. The core layer of polyethylene terephthalate fibers 490 may be a mat formed entirely of polyethylene terephthalate fibers, modified polyethylene terephthalate fibers, or a mixture of polyethylene terephthalate fibers and modified polyethylene terephthalate fibers. In some embodiments, other fibers may be included in the core layer 490 to enhance acoustical absorption at particular frequencies and/or to act as a barrier for noise at certain frequencies. In preferred embodiments, only one type of polyethylene terephthalate fiber is present in the mat. A composite material 320 fed from a roll 330 is then laminated onto the third adhesive layer 500 and covered by a fourth adhesive layer 510 such that the composite material 320 is sandwiched between the third and fourth adhesive layers 500, 510. The fourth adhesive layer 510 is formed by depositing a third adhesive 520 from a dispensing apparatus 430. The second layered material thus produced may be formed of sequential layers of a polyethylene terephthalate fibers 490, a third adhesive layer 500, a composite material layer 320, and a fourth adhesive layer 510.

As depicted in FIG. 5, the first and second assembly lines may converge in-line in a manner such that the second adhesive layer 460 is positioned adjacent to the layer of polyethylene terephthalate 490. The layered composite product 530, shown schematically in FIG. 6, may be formed of consecutive layers of a scrim 440, a first adhesive layer 410, a layer of the composite material 320, a second adhesive layer 460, a polyethylene terephthalate fiber layer 490, a third adhesive layer 500, a second layer of composite material 320, and a second adhesive layer 510. The layered composite product 530 may be passed through a lamination oven (not shown) where heat and pressure are applied to form a final laminated composite material (not shown). The laminated composite material may be further processed by conventional methods into composite products such as a liner for an automobile. For example, the laminated composite material may be trimmed and formed into a headliner, such as by a molding process. Foam or fabric may then be applied to the headliner for aesthetic purposes. The first, second, third, and fourth adhesives include adhesives such as copolymers of ethylene and vinyl acetate (EVA), copolymers of ethylene and acetic acid (EAA), acid modified polyethylenes, copolyamides, and ethyl acrylate. The adhesives may be the same or different from each other, and may be in a liquid form, a foam form, or a powdered form. Preferably the adhesives are liquid adhesives. It should be appreciated that although the above-described laminate process has been described in what is believed to be the preferred embodiment, other variations and alternatives to this process identifiable to those of skill in the art are also considered to be within the purview of the invention. For example, in an alternate embodiment (not shown), the laminate composite material may be formed by sequentially depositing layers of a scrim 440, a first adhesive layer 410, a layer of the composite material 320, a second adhesive layer 460, a polyethylene terephthalate core fiber layer 490, a third adhesive layer 500, a second layer of composite material 320, and a second adhesive layer 510.

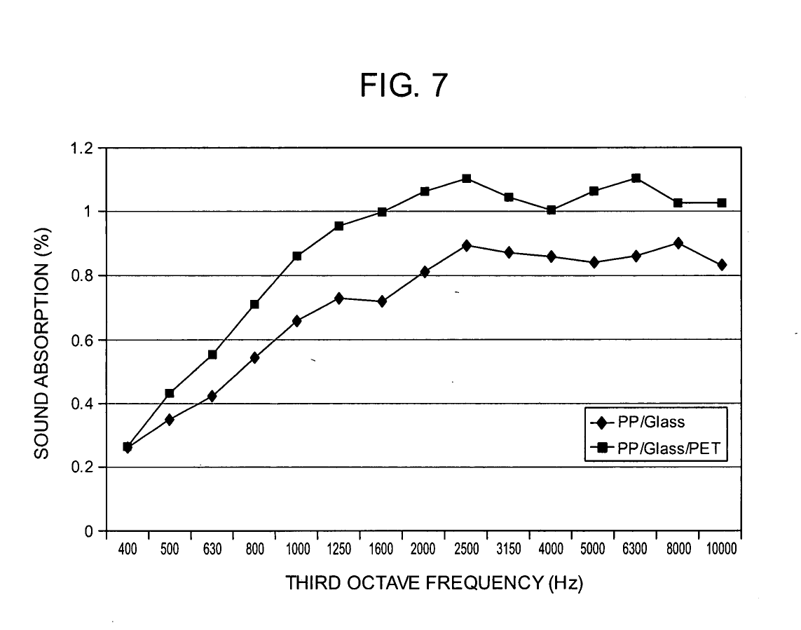

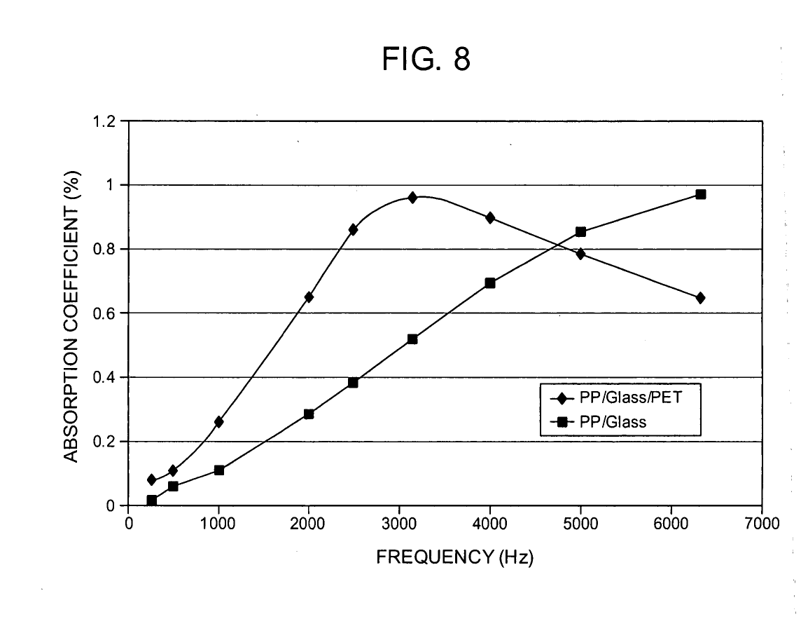

The composite material according to the present invention forms a final product that demonstrates improved sound absorption properties, especially at lower frequencies (such as 2000 Hz and below). Such improved sound absorption qualities may be seen in the examples depicted in FIGS. 7 and 8. Turning first to FIG. 7, it can be seen that the composite material of the present invention (the polypropylene/glass/polyethylene terephthalate composite material) absorbed more incident sound at all frequencies compared to a conventional composite material formed of polypropylene and glass fibers. Thus, not only does the inventive composite material demonstrate improved sound absorption at lower frequencies, it also provides improved sound absorption at both mid-range and higher frequencies. FIG. 8 depicts a graphical illustration of the normal incidence curves of an inventive composite material formed of polyethylene terephthalate fibers (PET) and glass fibers and a conventional composite material formed of organic fibers and glass fibers and no acoustical enhancement fibers. As shown in FIG. 8, the composite material containing the polyethylene terephthalate fibers (acoustical enhancement fibers) has a greatly improved absorption coefficient percentage compared to a conventional polypropylene glass composite at frequencies below approximately 4500 Hz. The increased sound absorption qualities in the lower frequencies provided by the inventive composite material, as shown in FIGS. 7 and 8, provides less internal compartment noise in an automobile from sources such as from road noise, tire noise, engine noise, and/or wind noise and, as a result, provides more comfort to the passengers and drivers of automobiles. For example, road noise typically occurs between approximately 30-1000 Hz, engine noises between approximately 500-4000 Hz, tire noise between approximately 800-2000 Hz, and wind noise between approximately 2000-4000 Hz. Further, the composite product provides the structural integrity and stiffness needed for structural applications that conventional composites materials available in the market today lack.

The acoustic performance of the composite material may be altered or improved by the specific combination of fibers present in the composite material, and can therefore be tailored to meet the needs of a particular application. For example, the acoustic properties desired for specific applications can be optimized by altering the weight of the fibers, by changing the reinforcement fibers content and/or length or diameter of the reinforcement fibers, or by altering the fiber length and/or denier of the acoustical enhancing fibers or organic fibers. The thickness of the formed composite part, porosity of the formed composite part (void content), and the air flow path may be controlled by changing the basis weight of the organic fibers and/or glass content of the composite material. In addition, the use of wet use chopped strand glass in the dry-laid process as described above also contributes to the improved sound absorption of the inventive composite material because the composite materials formed by the dry-laid process described herein has a higher loft (increased porosity).

Further, the composite material provides the ability to optimize and/or tailor the physical properties (such as stiffness and/or strength) needed for specific applications by altering the weight, length, and/or diameter of the reinforcement fibers and/or organic fibers used in the composite material. In addition, composite materials formed by the processes described herein have a uniform or substantially uniform distribution of fibers, thereby providing improved strength as well as improved acoustical and thermal properties, stiffness, impact resistance, and acoustical absorbance.

It is another advantage of the present invention that when wet use chopped strand glass fibers are used as the reinforcing fiber material, the glass fibers may be easily opened and fiberized with little generation of static electricity due to the moisture present in the glass fibers. In addition, wet use chopped strand glass fibers are less expensive to manufacture than dry chopped fibers because dry fibers are typically dried and packaged in separate steps before being chopped. Therefore, the use of wet use chopped strand glass fibers allows the products formed from the composite material to be manufactured with lower costs.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

Having thus described the invention, what is claimed is:

1. A method of making an acoustic and thermally absorbent composite material comprising the steps of:
at least partially opening bales of wet reinforcing fibers;
removing water from said at least partially opened wet reinforcing fibers to form dehydrated reinforcing fibers;
blending said dehydrated reinforcing fibers with organic fibers and acoustical enhancement fibers to form a substantially homogenous mixture of said dehydrated reinforcing fibers, said organic fibers, and said acoustical enhancement fibers;
forming said mixture into a sheet; and
bonding at least some of said dehydrated reinforcing fibers, said organic fibers, and said acoustical enhancement fibers to form a composite material.

2. The method of claim 1, wherein said bonding step comprises:
subjecting said sheet to a needling process to mechanically bond said dehydrated reinforcing fibers, said organic fibers, and said acoustical enhancement fibers.

3. The method of claim 1, wherein said bonding step comprises:
heating said sheet to a temperature above the melting point of at least one of said organic fibers and said acoustical enhancement fibers and below the melting point of said dehydrated reinforcing fibers to at least partially melt at least one of said organic fibers and said acoustical enhancement fibers.

4. The method of claim 1, further comprising the step of:
adding a bonding agent prior to said bonding step, said bonding agent being selected from the group consisting of resin powders, resin flakes, latex polymers, resin granules, adhesive foams and organic solvents.

5. The method of claim 1, wherein said forming step comprises:
passing said mixture through at least one sheet former.

6. The method of claim 5, further comprising the step of:
transporting said mixture to a filling box tower prior to said forming step, said filling box tower volumetrically feeding said mixture to said sheet former.

7. The method of claim 1, wherein said organic fibers are selected from the group consisting of bicomponent fibers, polyester fibers, polyethylene fibers, polypropylene fibers, polyethylene terephthalate (PET) fibers, polyphenylene sulfide (PPS) fibers, polyvinyl chloride (PVC) fibers, ethylene vinyl acetate/vinyl chloride (EVA/VC) fibers, lower alkyl acrylate polymer fibers, acrylonitrile polymer fibers, partially hydrolyzed polyvinyl acetate fibers, polyvinyl alcohol fibers, polyvinyl pyrrolidone fibers, styrene acrylate fibers, polyolefins, polyamides, polysulfides, polycarbonates, rayon, nylon and butadiene copolymers.

8. The method of claim 7, wherein said acoustical enhancement fibers are selected from the group consisting of polyethylene terephthalate (PET) fibers and modified polyethylene terephthalate fibers.

9. The method of claim 8, wherein said wet reinforcing fibers are wet use chopped strand glass fibers.

10. A composite mat made by the method of claim 1.

11. A method of forming a laminate composite product comprising the steps of:
forming a first layered material including:
depositing a first adhesive layer formed of a first adhesive onto a first scrim;
positioning a layer of a first composite material on said first adhesive layer, said composite material including dehydrated wet reinforcing fibers, organic fibers, and acoustical enhancement fibers;
placing a second adhesive layer formed of a second adhesive on said first composite material layer;
forming a second layered material including:
depositing a third adhesive layer formed of a third adhesive onto a core layer, said core layer being formed of a member selected from the group consisting of polyethylene terephthalate fibers, modified polyethylene terephthalate fibers and combinations thereof;
placing a layer of a second composite material including said reinforcing fibers, said acoustical enhancement fibers, and said organic fibers on said third adhesive layer; and
depositing a fourth adhesive layer formed of a fourth adhesive onto said second composite material layer; and
positioning said second layered material and said first layered material such that said second adhesive layer is located adjacent to said core layer to form a laminate composite product.

12. The method of claim 11, wherein said laminate composite product is a headliner for an automobile and said method further comprises the steps of:
trimming said laminate composite product; and
molding said trimmed laminate composite product into a headliner.

13. The method of claim 12, further comprising the step of:
heating said laminate composite product prior to said trimming step.

14. The method of claim 11, further comprising the step of forming said composite material, said forming step comprising:
at least partially opening bales of wet reinforcing fibers;
removing water from said at least partially opened wet reinforcing fibers to form dehydrated reinforcing fibers;
blending said dehydrated reinforcing fibers with organic fibers and acoustical enhancement fibers to form a substantially homogenous mixture of said dehydrated reinforcing fibers, said organic fibers, and said acoustical enhancement fibers;
forming said mixture into a sheet; and
bonding at least some of said dehydrated reinforcing fibers, said organic fibers, and said acoustical enhancement fibers to form said composite material.

15. The method of claim 11, wherein said first, second, third, and fourth adhesives have a form selected from the group consisting of a liquid form, a foam form and a powdered form.

16. A method of making a composite material comprising the steps of:
at least partially opening bales of wet reinforcing fibers;
removing water from said at least partially opened wet reinforcing fibers to form dehydrated reinforcing fibers;
blending said dehydrated reinforcing fibers with organic fibers to form a substantially homogenous mixture of said dehydrated reinforcing fibers and said organic fibers;
forming said mixture into a sheet;
bonding said reinforcing fibers and organic fibers in said sheet to form a first layer; and
affixing a second layer formed of acoustical enhancement fibers to said first layer to form a composite material, said acoustical enhancement fibers being selected from the group consisting of polyethylene terephthalate fibers and modified polyethylene terephthalate fibers.

17. The method of claim 16, wherein said organic fibers are selected from the group consisting of bicomponent fibers, polyester fibers, polyethylene fibers, polypropylene fibers, polyethylene terephthalate (PET) fibers, polyphenylene sulfide (PPS) fibers, polyvinyl chloride (PVC) fibers, ethylene vinyl acetate/vinyl chloride (EVA/VC) fibers, lower alkyl acrylate polymer fibers, acrylonitrile polymer fibers, partially hydrolyzed polyvinyl acetate fibers, polyvinyl alcohol fibers, polyvinyl pyrrolidone fibers, styrene acrylate fibers, polyolefins, polyamides, polysulfides, polycarbonates, rayon, nylon and butadiene copolymers.

18. The method of claim 17, wherein said wet reinforcing fibers are wet use chopped strand glass fibers.

19. The method of claim 16, wherein said bonding step comprises:
heating said sheet to a temperature above the melting point of said organic fibers and below the melting point of said dehydrated reinforcing fibers to at least partially melt said organic fibers and bond at least a portion of said dehydrated reinforcing fibers and said organic fibers.

20. The method of claim 19, further comprising the step of:
subjecting said sheet to a needling process to mechanically bond said dehydrated reinforcing fibers and said organic fibers prior to said bonding step.

21. The method of claim 15, further comprising the step of:
adding a bonding agent prior to said bonding step, said bonding agent being selected from the group consisting of resin powders, resin flakes, latex polymers, resin granules, adhesive foams and organic solvents.
